(19) United States
(12) Patent Application Publication
(10) Pub. No.: US 2023/0018573 A1
(43) Pub. Date: Jan. 19, 2023

(54) SHOOTING TARGET COLLATION METHOD, SHOOTING TARGET COLLATION DEVICE, AND PROGRAM

(71) Applicant: NIPPON TELEGRAPH AND TELEPHONE CORPORATION, Tokyo (JP)

(72) Inventors: Hiroyuki ISHIHARA, Musashino-shi, Tokyo (JP); Shiro KUMANO, Musashino-shi, Tokyo (JP); Takayuki NAKACHI, Musashino-shi, Tokyo (JP)

(73) Assignee: NIPPON TELEGRAPH AND TELEPHONE CORPORATION, Tokyo (JP)

(21) Appl. No.: 17/785,382

(22) PCT Filed: Dec. 17, 2019
(86) PCT No.: PCT/JP2019/049452

§ 371 Date: Jun. 14, 2022

(51) Int. Cl. G06T 7/246; G06V 10/74

(52) U.S. Cl. CPC G06T 7/248; G06V 10/761; G06V 2201/07; G06T 2207/10016

(57) ABSTRACT

An object of the invention is to provide a photographed target matching method and the like which allows video image data including a plurality of photographed targets and sensor data from terminals worn by the targets to be automatically associated with one another, so that a data set for analysis can be produced. According to the photographed target matching method according to the present invention, a gravitational acceleration component g_{c} in a camera coordinate system is estimated for an arbitrary combination of a photographed target j in the camera video image and a terminal i from acceleration vectors a_{c}^{(j)}(t) of a plurality of photographed targets j produced from video image data from the camera and acceleration vectors a_{d}⁽ⁱ⁾(t) obtained from the sensors of terminals i worn by the plurality of photographed targets, and a combination of (i, j, τ) is obtained which maximizes the correlation between an acceleration vector (a_{c}^{(j)}+g_{c}) in the video data obtained by adding the gravitational acceleration component in a camera coordinate system and the acceleration vector a_{d}⁽ⁱ⁾(t) of the terminal when these vectors are shifted by the estimated time gap τ and compared to match the target in the camera video image and the terminal.

### TECHNICAL FIELD

The present disclosure relates to a technique for automatically integrating signals from a plurality of sensors.

### BACKGROUND ART

The demand for data produced by integrating I/O signals from different devices has been increasing since such data may find applications in various fields for example through deep learning. For example, information related to interaction among human motion, facial expression, and body data obtained from video image data and sensor data for example from wearable terminals is expected to be used in healthcare, working environment management, and the like. For example, NPL 1 describes a method for detecting the track of a terminal using 3D motion interrelation between moving images and the acceleration of a wearable device.

### CITATION LIST

### Non Patent Literature

[NPL 1] A. D. Wilson and H. Benko: “CrossMotion: Fusing Device and Image Motion for User Identification, Tracking and Device Association”, In Proc. of International Conference on Multimodal Interaction (ICMI), 2014

### SUMMARY OF THE INVENTION

### Technical Problem

However, in the disclosure of NPL 1, only one person carries a wearable terminal among a plurality of persons included in a moving image. Therefore, by the method according to NPL 1, there is a problem that video image data about a plurality of persons and sensor data from terminals worn by the persons cannot be automatically associated to produce a data set for analysis.

Therefore, in order to solve the problem, it is an object of the present invention to provide a photographed target matching method, a photographed target matching device, and a program which allow video image data including a plurality of photographed targets and sensor data from terminals worn by the targets to be automatically associated.

### Means for Solving the Problem

In order to achieve the object, according to a photographed target matching method according to the present invention, when acceleration data ac estimated from the image of a person taken by a camera is compared with the acceleration data as of the device carried by each person, a gravitational acceleration component missing in the acceleration data a_{c} is estimated and compensated for.

Specifically, the photographed target matching method according to the present invention includes photographing a moving image including a plurality of targets j by a fixed camera, obtaining acceleration vectors a_{c}^{(j)}(t) of the photographed targets j from the moving image, obtaining acceleration vectors a_{d}⁽ⁱ⁾(t) of terminals i carried by the photographed targets j, estimating a gravitational acceleration vector g_{c} in a camera coordinate system for an arbitrary combination of the photographed target j and the terminal i from the acceleration vectors a_{c}^{(j)}(t) and the acceleration vectors a_{d}⁽ⁱ⁾(t), and adding the gravitational acceleration vector g_{c} to the acceleration vector a_{c}^{(j)}(t) and comparing the result with the acceleration vector a_{d}⁽ⁱ⁾(t) to match the photographed target j included in the moving image and data in the terminal i.

Here, an example of the estimation will be described. The estimation includes extracting M samples from each of the acceleration vectors a_{c}^{(j)}(t) and the acceleration vectors a_{d}⁽ⁱ⁾(t), and estimating a gravitational acceleration vector g_{c} or a gravitational acceleration vector g′_{c} in a coordinate system for the fixed camera by formulating simultaneous equations, Expression C1 or C2 from the samples.

Note that Expression C2 is obtained by extending Expression C1 when it is assumed that the terminals i are synchronized in time. The gravitational acceleration vectors are described as “g_{c}” and “g′_{c}” in order to indicate which expression is used for calculating each vector.

$$\begin{matrix}[ Math C1 ] & \\ [ \begin{matrix}{a}_{c : 1}^{( j ) ⊤} ( t ) \\ ⋮ \\ {a}_{c : M}^{( j ) ⊤} ( t )\end{matrix} ] {ℊ}_{c} = \frac{1}{2} [ \begin{matrix}{‖ {a}_{d : 1}^{( i )} ( t ) ‖}_{2}^{2} - {‖ {a}_{c : 1}^{( j )} ( t ) ‖}_{2}^{2} - {9.8}^{2} \\ ⋮ \\ {‖ {a}_{d : M}^{( i )} ( t ) ‖}_{2}^{2} - {‖ {a}_{c : M}^{( j )} ( t ) ‖}_{2}^{2} - {9.8}^{2}\end{matrix} ] & ( C1 )\end{matrix}$$

$$⇔ A {ℊ}_{c} = b$$

$$⇔ {ℊ}_{c} = arg {min}_{{ℊ}_{c}} {‖ A {ℊ}_{c} - b ‖}_{2}^{2}$$

$$\begin{matrix}[ Math C2 ] & \\ {A}^{′} {ℊ}_{c}^{′} = {b}^{′} ⇔ {ℊ}_{c}^{′} = arg {min}_{{ℊ}_{c}^{′}} {‖ {A}^{′} {ℊ}_{c}^{′} - {b}^{′} ‖}_{2}^{2} & ( C2 )\end{matrix}$$

$${A}^{′} = [ \begin{matrix}{\sum }_{k = 1}^{N} {a}_{c : 1}^{( k ) ⊤} ( t ) \\ ⋮ \\ {\sum }_{k = 1}^{N} {a}_{c : M}^{( k ) ⊤} ( t )\end{matrix} ]$$

$${b}^{′} = \frac{1}{2} [ \begin{matrix}{\sum }_{k = 1}^{N} {‖ {a}_{d : 1}^{( k )} ( t ) ‖}_{2}^{2} - {\sum }_{k = 1}^{N} {‖ {a}_{c : 1}^{( k )} ( t ) ‖}_{2}^{2} - {9.8}^{2} N \\ ⋮ \\ {\sum }_{k = 1}^{N} {‖ {a}_{d : M}^{( k )} ( t ) ‖}_{2}^{2} - {\sum }_{k = 1}^{N} {‖ {a}_{c : M}^{( k )} ( t ) ‖}_{2}^{2} - {9.8}^{2} N\end{matrix} ]$$

Note that i is the number attached to the terminal (1, 2, . . . , N), j is the number attached to the photographed target (1, 2, . . . , N), t is time, M is a sample number (1, 2, . . . , M), T is the transposed matrix, and ∥x∥₂ is the L2 norm of vector x.

The photographed target matching device according to the present invention includes an input unit to which acceleration vectors a_{c}^{(j)}(t) of photographed targets included in a moving image photographed by a fixed camera and acceleration vectors a_{d}⁽ⁱ⁾(t) measured by terminals carried by the photographed targets are input, an estimating unit which estimates a gravitational acceleration vector g_{c} in a camera coordination system for an arbitrarily combination of the photographed target j and the terminal i from the acceleration vectors a_{c}^{(j)}(t) and the acceleration vectors a_{d}⁽ⁱ⁾(t), and a detecting unit which adds the gravitational acceleration vector g_{c} to the acceleration vector a_{c}^{(j)}(t) and compares the result with the acceleration vector a_{d}⁽ⁱ⁾(t) to match the photographed target j included in the moving image and data in the terminal i.

Here, the photographed target matching device according to the present invention preferably includes, preceding to the estimating unit, an extracting unit which extracts M samples each from the acceleration vector a_{c}^{(j)}(t) and the acceleration vector a_{d}⁽ⁱ⁾(t), and the estimating unit estimates the gravitational acceleration vector g_{c}or the gravitational acceleration vector g′_{c} in the coordinate system of the fixed camera by formulating simultaneous equations as Expression C1 or C2 from the samples.

The program according to the present invention is a program for causing a computer to execute the above-described photographed target matching method.

The photographed target matching method according to the present invention focuses on motion information and searches for a combination of acceleration information about a person in a video image and acceleration sensor information in the wearable terminal having maximum correlation. In this case, the accelerometer of the wearable terminal includes a gravitational acceleration component in addition to wearer's motion, while acceleration information about the person estimated from the camera video image is only the component of the wearer's motion. Therefore, it is difficult to directly correlate these values and to accurately match the target in the camera video image with the sensor data because the method as described in NPL 1 does not take the gravitational acceleration component into account.

According to the photographed target matching method according to the present invention, the gravitational acceleration component g_{c} in the camera coordinate system is estimated for an arbitrary combination of a photographed target j in the camera video image and a terminal i from the acceleration vectors a_{c}^{(j)}(t) of a plurality of photographed targets j generated from the video image data from the camera and the acceleration vectors a_{d}⁽ⁱ⁾(t) obtained from the sensors of the terminals i worn by the plurality of photographed targets. Then, according to the photographed target matching method according to the present invention, the acceleration vector (a_{c}^{(j)}+g_{c}) of the video image data obtained by adding the gravitational acceleration component in the camera coordinate system is compared with the acceleration vector a_{d}⁽ⁱ⁾(t) of the terminal to perform the matching.

The photographed target matching method according to the present invention further includes calculating motion similarity between the acceleration vector a_{d}⁽ⁱ⁾(t) and acceleration obtained by adding the gravitational acceleration vector g_{c} to the acceleration vector a_{c}^{(j)}(t) in matching the photographed target included in the moving image and the data in the terminal, calculating gravitational acceleration similarity between the gravitational acceleration vector g_{c} and the gravitational acceleration vector g′_{c} estimated assuming that the terminals i are synchronized in time, and detecting a combination of the terminal i and the photographed target j which maximizes an objective function obtained as a weighted sum of the motion similarity and the gravitational acceleration similarity.

A specific example will be given.

The gravitational acceleration vector g_{c} and the gravitational acceleration vector g′_{c} are estimated from Expressions C1 and C2 for each combination of i, j, and τ, and the combination of i, j, and τ which maximizes the objective function represented by Expression C3 is detected.

$$\begin{matrix}[ Math C3 ] & \\ {d}_{i , j , τ} = \frac{1}{1 + λ} ( {f}_{m}^{( i , j )} ( τ ) + λ {f}_{ℊ}^{( i , j )} ( τ ) ) & ( C3 )\end{matrix}$$

In Expression C3, the motion similarity fₘ^{(i,j)}(τ) and gravitational acceleration similarity f_{g}^{(i,j)}(τ) are represented by the following expression.

$$\begin{matrix}[ Math C4 ] & \\ {f}_{m}^{( i , j )} ( τ ) = \frac{{( {s}_{d}^{i} ( t ) - \overline{{s}_{d}^{i}} ( t ) )}^{⊤} ( {s}_{c}^{j} ( t + τ ) - \overline{{s}_{c}^{j}} ( t + τ ) )}{{‖ ( {s}_{d}^{i} ( t ) - \overline{{s}_{d}^{i}} ( t ) ) ‖}_{2} {‖ ( {s}_{c}^{j} ( t + τ ) - \overline{{s}_{c}^{j}} ( t + τ ) ) ‖}_{2}} , & ( C4 )\end{matrix}$$

$${f}_{ℊ}^{( i , j )} ( τ ) = \frac{{ℊ}_{c}^{( i , j ) ⊤} ( τ ) {ℊ}_{c}^{′} ( τ )}{{‖ {ℊ}_{c}^{( i , j )} ( τ ) ‖}_{2} {‖ {ℊ}_{c}^{′} ( τ ) ‖}_{2}} ,$$

$${s}_{d}^{( i )} ( t ) = {‖ {a}_{d}^{( i )} ( t ) ‖}_{2}$$

$${s}_{c}^{( j )} ( t + τ ) = {‖ {a}_{c}^{( j )} ( t + τ ) + {ℊ}_{c}^{( i , j )} ( τ ) ‖}_{2} ,$$

where τ is the time lag between the terminal and the photographed target, λ is an arbitrary weight coefficient, and x̅ is the average time of the vector x.

The estimating unit of the photographed target matching device according to the present invention also estimates the gravitational acceleration vector g′_{c} on the basis of the assumption that the terminals i are synchronized in time, the detecting unit calculates, when matching the photographed target j included in the moving image and data in the terminal i, calculates motion similarity between the acceleration vector a_{d}⁽ⁱ⁾(t) and an acceleration obtained by adding the gravitational acceleration vector g_{c} to the acceleration vector a_{c}^{(j)}(t), calculates gravitational acceleration similarity between the gravitational acceleration vector g_{c} and the gravitational acceleration vector g′_{c}, and detects a combination of the terminal i and the photographed target j which maximizes an objective function obtained as a weighted sum of the motion similarity and the gravitational acceleration similarity.

Specifically, the estimating unit estimates the gravitational acceleration vector g_{c} and the gravitational acceleration vector g′_{c} for each combination of i, j, and τ from Expressions C1 and C2, and the detecting unit detects the combination of i, j, and τ which maximizes the objective function represented by Expression C3 when the photographed target included in the moving image and data in the terminal are matched.

According to the photographed target matching method according to the present invention, a video image taken by a camera and a terminal are matched by obtaining a combination of (i, j, τ) which maximizes the correlation fₘ^{(i, j)}(τ) when they are shifted by the estimated time lag (τ) in the matching and compared.

Here, the gravitational acceleration component estimated using Expression C1 has a different value depending on the combination of (i, j, τ), and takes a correct value fora correct combination. Also, the gravitational acceleration component estimated using Expression C2 depends only on τ and takes a correct value when the correct τ is used. In other words, for the correct combination of (i, j, τ), the gravitational acceleration component estimated with Expression C1 is equal to the gravitational acceleration component estimated with Expression C2. The photographed target matching method makes use of this and takes into account the correlation f_{g}^{(i,j)}(τ) of the estimated gravitational acceleration component in addition to the acceleration correlation fₘ^{(i,j)}(τ).

Specifically, according to the photographed target matching method, the gravitational acceleration component g_{c}^{(i, j)} (τ) in the camera coordinate system are estimated for all the combinations of the photographed targets j in the camera video image and the terminals i and the combination of (i, j, τ) which maximizes Expression C3 is obtained.

According to the method, the gravitational acceleration component in the camera video image can be estimated only from observation signals obtained from the camera or the terminal. Therefore, it is not necessary to carry out calibration separately using an acceleration sensor, and matching between multiple photographed targets included in the video image data and sensor data can be performed highly accurately and automatically.

Therefore, the present invention can provide a photographed target matching method, a photographed target matching device, and a program which allow video image data including a plurality of photographed targets and sensor data from terminals worn by the targets to be automatically associated with each other.

The above features of the present invention can be combined in any way possible.

### Effects of the Inventions

The present invention can provide a photographed target matching method, a photographed target matching device, and a program which allow video image data including a plurality of photographed targets and sensor data from terminals worn by the targets to be automatically associated with each other.

### BRIEF DESCRIPTION OF DRAWINGS

FIG. 1 illustrates a measuring system including a photographed target matching device according to the present invention.

FIG. 2 illustrates a coordinate system for a fixed camera and a coordinate system for a wearable device.

FIG. 3 is a diagram for illustrating the photographed target matching device according to the present invention.

FIG. 4 illustrates the advantageous effect of the photographed target matching device according to the present invention.

FIG. 5 is a flowchart for illustrating the photographed target matching method according to the present invention.

FIG. 6 is a diagram for illustrating the photographed target matching device according to the present invention.

### DESCRIPTION OF EMBODIMENTS

Embodiments of the present invention will be described in conjunction with the accompanying drawings. The following embodiments are examples only and are not intended to limit the present invention. The elements denoted by the same reference characters refer to the same elements in the specification and the drawings.

[Measuring System]

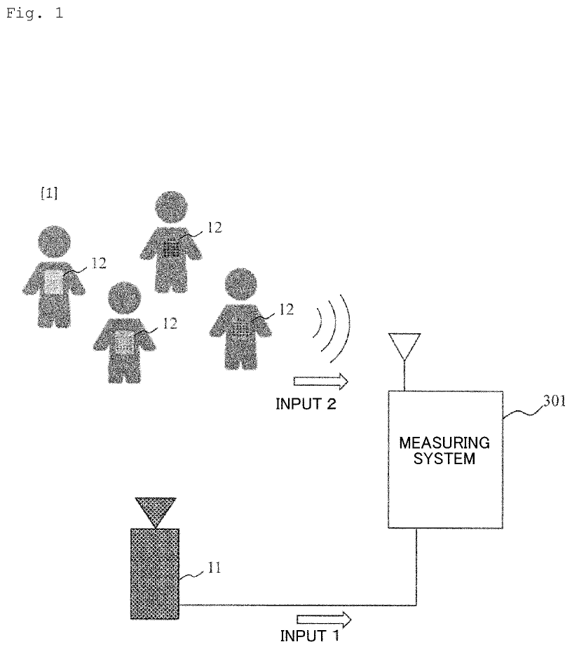

FIG. 1 illustrates a measuring system including a photographed target matching device 301 according to an embodiment of the invention. The measuring system includes a photographed target matching device 301, a fixed camera 11, a wearable device 12 carried by a person to be photographed target by the fixed camera 11. The fixed camera 11 records, as a video image (moving image) , the action and communication of each person as a measuring target. Hereinafter, the video image may be referred to as “RGB-D video”. Each person to be photographed target wears the wearable device 12 unique to the person. The wearable devices 12 each include an accelerometer and measures the motion of a target to be photographed (person) as acceleration. The wearable devices 12 is, for example, a smart phone.

The wearable devices 12 and the fixed camera 11 have their own clocks and give timestamps to moving images and acceleration data according to the clocks. It is not guaranteed that the clock of each of the wearable devices 12 and the clock of the fixed camera 11 are synchronized with each other.

[Definitions]

The definitions of parameters which appear in the following description will be described.

N is the number of targets (number of people) to be photographed.

t is time.

An acceleration signal (vector) measured with a wearable device 12-i is represented as follows.

[Math A01]

a_{d}⁽ⁱ⁾(t) (i=1,2, . . . , N) (A01)

The vector has three axis components for x, y, and z axes. The coordinate system depends on the direction of the wearable device 12 (changing with time).

The acceleration signal (vector) of a photographed target (person) j in a video image is represented as follows.

[Math A02]

a_{c}^{(j)}(t) (j=1,2, . . . , N) (A02)

The vector has three axis components for x, y, and z axes. The coordinate system depends on the direction of the fixed camera 11.

A gravitational acceleration component (vector) measured with the wearable device 12-i is represented as follows.

[Math A03]

g_{d}⁽ⁱ⁾(t) (i=1,2, . . . , N) (A03)

The coordinate system depends on the direction of the wearable device 12 (changing with time).

The result of matching between the ID of a wearable device estimated by the photographed target matching device 301 and the ID of a person in the camera is represented as follows.

[Math A04]

C*={(iₙ*,jₙ*)} (n=1,2, . . . , N) (A04)

where τ is the timestamp lag between the real fixed camera 11 and the wearable device 12, and τ* is the timestamp lag between the fixed camera 11 estimated by the photographed target matching device 301 and the wearable device 12.

The track (vector) of a photographed target (person) j in a video image is represented as follows.

[Math A05]

P_{c}^{(j)}(t) (j=1,2, . . . , N) (A05)

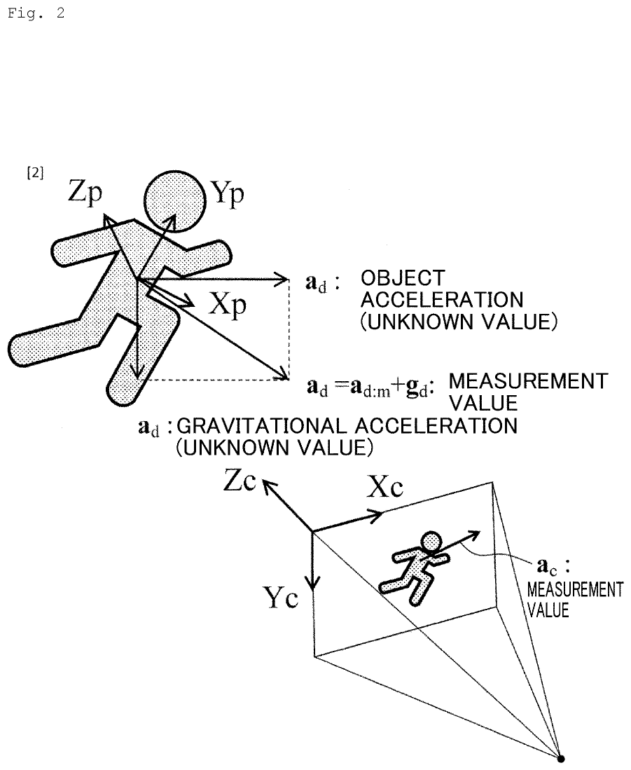

FIG. 2 illustrates the coordinate system of the fixed camera 11 and the coordinate system of the wearable device 12. As shown in FIG. 2, the coordinate systems of these devices are different. The coordinate systems of the wearable devices 12 are also different among one another because the people move freely.

[Object]

The photographed target matching device 301 is directed to estimation of the following two things.
(1) Matching C*
(2) Lag amount τ*

[Assumption]

It is assumed that during measuring, all the photographed targets (persons) are visible in a video image.

It is assumed that the timestamps between the plurality of wearable devices 12 are synchronized in a known manner.

[Details]

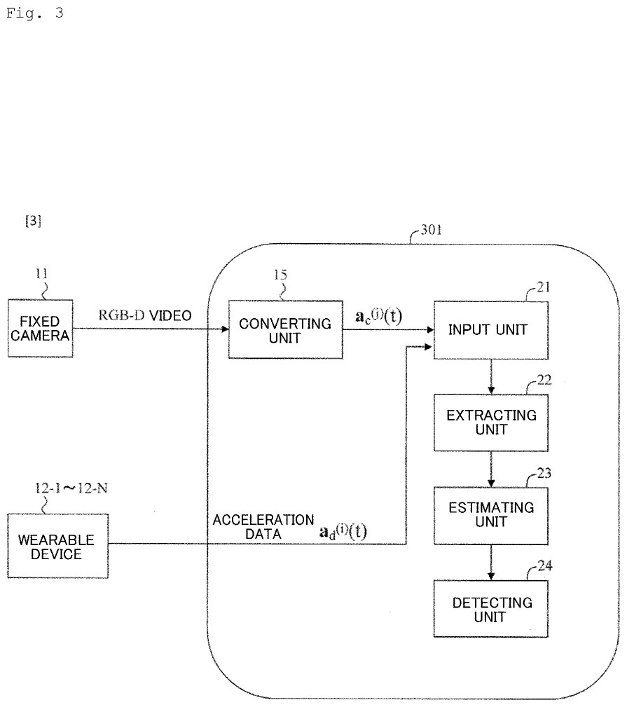

FIG. 3 is a diagram for illustrating the photographed target matching device 301. The photographed target matching device 301 includes an input unit 21 which is provided, as inputs, with the acceleration vectors a_{c}^{(j)}(t) of the photographed targets included in a moving image captured by the fixed camera 11 and acceleration vectors a_{d}⁽ⁱ⁾(t) measured by the wearable devices 12 carried by the photographed targets, an extracting unit 22 which extracts M samples from each of the acceleration vectors a_{c}^{(j)}(t) and the acceleration vectors a_{d}⁽ⁱ⁾(t), an estimating unit 23 which estimates a gravitational acceleration vector g_{c} or a gravitational acceleration vector g′_{c} in the coordinate system of the fixed camera by formulating simultaneous equations with Expression C1 or C2 from the samples, and a detecting unit 24 which adds the gravitational acceleration vector g_{c} or the gravitational acceleration vector g′_{c} to the acceleration vector a_{c}^{(j)}(t) and compares the result with the acceleration vector a_{d}⁽ⁱ⁾(t) to match the photographed target included in the moving image with the data in the terminal.

Data from Wearable Device 12

Each of persons to be photographed target wears a wearable device 12, and the wearable device 12 measures acceleration associated with the motion of the person. The wearable device 12 can also measure gravitational acceleration. Therefore, the acceleration data (vector) a_{d}⁽ⁱ⁾(t) output by the wearable device 12 can be represented by the following expression.

[Math 1]

a_{d}⁽ⁱ⁾(t)=a_{d:m}⁽ⁱ⁾(t)+g_{d}⁽ⁱ⁾(t) (1)

where a_{d:m}⁽ⁱ⁾(t) is acceleration by the motion of a person (an acceleration component other than the gravitational acceleration component), and g_{d}⁽ⁱ⁾(t) is the gravitational acceleration component.

Data from Fixed Camera 11

The fixed camera captures a moving image of N persons to be photographed target. The moving image is input to the converting unit 15. The converting unit 15 detects a person from the moving image using an existing person detection algorithm. The converting unit 15 also obtains the position P_{c}^{(j)}(t) (see Expression A05) of the detected person in the video image. Then, the converting unit 15 calculates the acceleration vector a_{c}^{(j)}(t) in Expression A02 using the following expression.

$$\begin{matrix}[ Math 2 ] & \\ {a}_{c}^{( j )} ( t ) ≃ \frac{{P}_{c}^{( j )} ( t + 2 Δ t ) + {P}_{c}^{( j )} ( t - 2 Δ t ) - 2 {P}_{c}^{( j )} ( t )}{4 Δ {t}^{2}} & ( 2 )\end{matrix}$$

Note that Δt is the frame rate of the moving image.

In FIG. 3, the photographed target matching device 301 includes the converting unit 15, but the converting unit 15 may be provided outside the photographed target matching device 301.

Here, the acceleration data a_{d}⁽ⁱ⁾(t) from the wearable device 12 includes a gravitational acceleration component, but the data a_{c}^{(j)}(t) from the fixed camera 11 converted by the converting unit 15 does not include a gravitational acceleration component. Therefore, the acceleration data a_{d}⁽ⁱ⁾(t) and the acceleration data a_{c}^{(j)}(t) cannot be compared directly.

Therefore, the photographed target matching device 301 introduces the gravitational acceleration g_{c} into the camera coordinate system. Since the fixed camera 11 is fixed, the gravitational acceleration g_{c} is estimated as a constant vector. The estimation method will be described in the following.

The following expression is established between the acceleration data a_{d}⁽ⁱ⁾(t) and the acceleration data a_{c}^{(j)}(t). In the expression, the subscripts i and j and the variable (t) are omitted.

[Math 3]

∥a_{c}∥₂=∥a_{d:m}∥₂,

a_{c}^{T}g_{c}=a_{d:m}^{T}g_{d},

∥g_{c}∥_{c}=∥g_{d}∥₂=9.8² [m/s²] (3)

where ∥x∥₂ is the L2 norm of the vector x, and x^{T} is the transposed matrix of the vector x.

The relation represented by the following expression is established from Expressions 1 and 3. Also in the following expression, the subscripts i and j and the variable (t) are omitted.

$$\begin{matrix}[ Math 4 ] & \\ \begin{matrix}{‖ {a}_{d} ‖}_{2}^{2} = {‖ {a}_{d : m} ‖}_{2}^{2} + 2 {a}_{d : m}^{⊤} {ℊ}_{d} + {‖ {ℊ}_{d} ‖}_{2}^{2} \\ = {‖ {a}_{c} ‖}_{2}^{2} + 2 {a}_{c}^{⊤} {ℊ}_{c} + {9.8}^{2}\end{matrix} & ( 4 )\end{matrix}$$

In Expression 4, the only unknown vector is g_{c}. Therefore, the extracting unit 22 extracts M samples each from the acceleration data a_{d}⁽ⁱ⁾(t) and the acceleration data a_{c}^{(j)}(t), and the estimating unit 23 formulates the following simultaneous equations to estimate g_{c}. Also in the following expression, the subscripts i and j and the variable (t) are also omitted.

$$\begin{matrix}[ Math 5 ] & \\ [ \begin{matrix}{a}_{c : 1}^{⊤} \\ ⋮ \\ {a}_{c : M}^{⊤}\end{matrix} ] {ℊ}_{c} = \frac{1}{2} [ \begin{matrix}{‖ {a}_{d : 1} ‖}_{2}^{2} - {‖ {a}_{c : 1} ‖}_{2}^{2} - {9.8}^{2} \\ ⋮ \\ {‖ {a}_{d : M} ‖}_{2}^{2} - {‖ {a}_{c : M} ‖}_{2}^{2} - {9.8}^{2}\end{matrix} ] & ( 5 )\end{matrix}$$

$$⇔ A {ℊ}_{c} = b$$

$$⇔ {ℊ}_{c} = {( {A}^{⊤} A )}^{- 1} {A}^{⊤} b$$

Note that g_{c} in a general expression is as follows.

[Math 5a]

g_{c}=argmin_{g}_{_{c}}∥Ag_{c}−b∥₂² (5a)

The M samples are acceleration data pieces at time t=t₁, t=t₂, . . . , and t=t_{M}, as shown in the example in the following expression.

[Math 5b]

M sample of a_{d}⁽ⁱ⁾(t)=[a_{d}⁽ⁱ⁾(t=t₁),a_{d}⁽ⁱ⁾(t=t₂), . . . , a_{d}⁽ⁱ⁾(t=t_{M-1}),a_{d}⁽ⁱ⁾(t=t_{M})] (5b)

Here, assuming that the timestamps between the wearable devices 12 are synchronized, Expression 5 can be extended as follows. Also in the following expression, the subscripts i and j and the variable (t) are omitted.

$$\begin{matrix}[ Math 6 ] & \\ {A}^{′} {ℊ}_{c}^{′} = {b}^{′} ⇔ {ℊ}_{c}^{′} = {( {A}^{′ ⊤} {A}^{′} )}^{- 1} {A}^{′ ⊤} {b}^{′} & ( 6 )\end{matrix}$$

$${A}^{′} = [ \begin{matrix}{\sum }_{k = 1}^{N} {a}_{c : 1}^{k ⊤} \\ ⋮ \\ {\sum }_{k = 1}^{N} {a}_{c : M}^{k ⊤}\end{matrix} ]$$

$${b}^{′} = \frac{1}{2} [ \begin{matrix}{\sum }_{k = 1}^{N} {‖ {a}_{d : 1} ‖}_{2}^{2} - {\sum }_{k = 1}^{N} {‖ {a}_{c : 1} ‖}_{2}^{2} - {9.8}^{2} N \\ ⋮ \\ {\sum }_{k = 1}^{N} {‖ {a}_{d : M} ‖}_{2}^{2} - {\sum }_{k = 1}^{N} {‖ {a}_{c : M} ‖}_{2}^{2} - {9.8}^{2} N\end{matrix} ]$$

Note that g′_{c} in a general expression is as follows.

[Math 6a]

g′_{c}=argmin_{g′}_{_{c}}∥A′g′_{c}−b′∥₂² (6a)

When the timestamps between the wearable devices 12 are synchronized, the effect of a large noise if any in a signal from any of the wearable devices 12 can be reduced.

In the following description, the gravitational acceleration component estimated by Expression 5 which depends on i, j and τ is expressed by

[Math A06]

g_{c}^{(i,j)}(τ) (A06)

While the gravitational acceleration component estimated by Expression 6 which depends only on τ is expressed by

[Math A07]

g′_{c}(τ) (A07)

The gravitational acceleration g_{c} according to Expression A06 or A07 estimated by the estimating unit 23 is added to the acceleration vector a_{c}^{(j)}(t) according to Expression 2, so that the result can be directly compared with the acceleration vector a_{d}⁽ⁱ⁾(t) according to Expression 1.

The direct comparison is made at the detecting unit 24. Here, a specific example of the direct comparison will be described. First, in order to compensate for the effect of the difference between the coordinate systems of the wearable device 12 and the fixed camera 11, the L-2 norms of the respective acceleration vectors are used as the feature quantities for comparison as shown in the following expressions.

[Math A08]

s_{d}ⁱ(t)=∥a_{d}⁽ⁱ⁾(t)∥₂ (A08)

[Math A09]

s_{c}^{j}(t+τ)=∥a_{c}^{(j)}(t+τ)+g′_{c}(τ)∥₂ (A09)

Expression A09 represents a vector obtained as s_{c}^{j}(t) is shifted by time τ.

The detecting unit 24 calculates the correlation between these two acceleration values by the following expression, and the combination of i, j, and τ which maximizes the correlation value is obtained as the estimation result.

$$\begin{matrix}[ Math 7 ] & \\ {f}_{m}^{( i , j )} ( τ ) = \frac{{( {s}_{d}^{i} ( t ) - \overline{{s}_{d}^{i}} ( t ) )}^{⊤} ( {s}_{c}^{j} ( t + τ ) - \overline{{s}_{c}^{j}} ( t + τ ) )}{{‖ ( {s}_{d}^{i} ( t ) - \overline{{s}_{d}^{i}} ( t ) ) ‖}_{2} {‖ ( {s}_{c}^{j} ( t + τ ) - \overline{{s}_{c}^{j}} ( t + τ ) ) ‖}_{2}} & ( 7 )\end{matrix}$$

s̅_̅{̅d̅}̅ⁱ̅(t) and s̅_̅{̅c̅}̅^̅{̅j̅}̅(t+τ) are the average values of s_{d}ⁱ(t) and s_{c}^{j}(t+τ) in the measurement period (t=0, . . . , Tₙ−1).

The correlation in Expression 7 will be referred to as “motion similarity”.

Here, the detecting unit 24 preferably introduces a parameter called Gravity Direction Consistency (GDC). The gravitational acceleration component in Expression A06 has different values depending on combinations of i, j, and τ, and is correct when the combination of i, j, and τ is correct. Meanwhile, the gravitational acceleration component in Expression A07 depends only on τ and has a correct value when τ is correct. More specifically, for the correct combination of i, j, and τ, the gravitational acceleration component with Expression A06 is equal to the gravitational acceleration component with Expression A07. GDC describes this constraint in the following expression representing “gravitational acceleration similarity”.

$$\begin{matrix}[ Math 8 ] & \\ {f}_{ℊ}^{( i , j )} ( τ ) = \frac{{ℊ}_{c}^{( i , j ) ⊤} ( τ ) {ℊ}_{c}^{′} ( τ )}{{‖ {ℊ}_{c}^{( i , j )} ( τ ) ‖}_{2} {‖ {ℊ}_{c}^{′} ( τ ) ‖}_{2}} & ( 8 )\end{matrix}$$

The detecting unit 24 generates a weighted sum of motion similarity in Expression 7 and gravitational acceleration similarity in Expression 8.

$$\begin{matrix}[ Math 9 ] & \\ {d}_{i , j , τ} = \frac{1}{1 + λ} ( {f}_{m}^{( i , j )} ( τ ) + λ {f}_{ℊ}^{( i , j )} ( τ ) ) & ( 9 )\end{matrix}$$

where λ is a weight coefficient (0≤λ≤1).

The detecting unit 24 further produces the following relation for each τ.

[Math A10]

C(τ)={c₁=(ĩ_{1,}\tilde{j}_{1,}), . . . , c_{N}=(ĩ_{N,}\tilde{j}_{N,})} (A10)

Here, c₁ to c_{N} in C(τ) are the combinations of the estimated photographed target j and the number (ID) of terminal i. The mark “˜” above i and j in Expression A10 indicates that it is ID after estimation.

Finally, the detecting unit 24 finds and outputs the set of i, j, and τ which maximizes the objective function as shown in the following expression.

$$\begin{matrix}[ Math 10 ] & \\ {τ}^{*} , {C}^{*} ( τ = {τ}^{*} ) = {arg max}_{τ , C ( τ )} \frac{1}{N} {\sum }_{c ∈ C ( τ )} {d}_{c , τ} & ( 10 )\end{matrix}$$

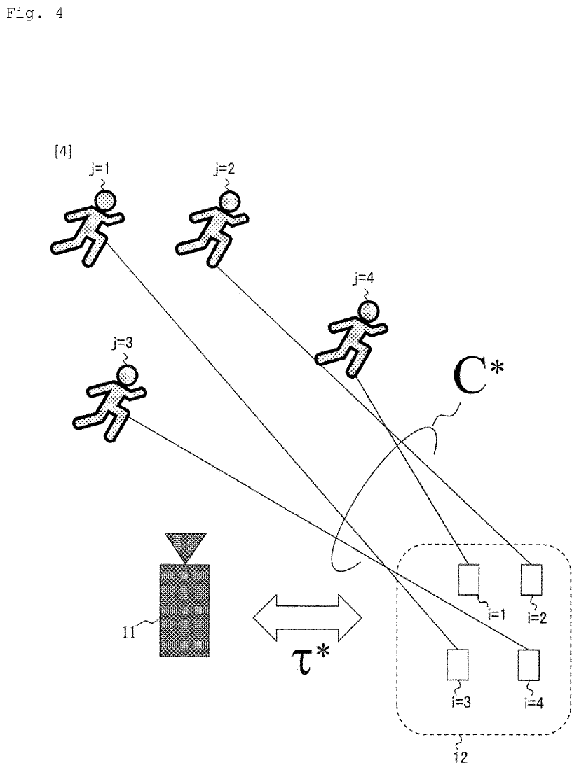

FIG. 4 illustrates the effect of the photographed target matching device 301. With the set of i, j, and τ output by the detecting unit 24, the person i in the video image data in the fixed camera 11 and sensor data from the wearable device 12-j can be matched with high accuracy. The amount of time lag between the wearable device 12 and the fixed camera 11 at the time can also be obtained.

Expressions 7 and 8 for calculating similarity are examples, and other expressions may be used to obtain similarity.

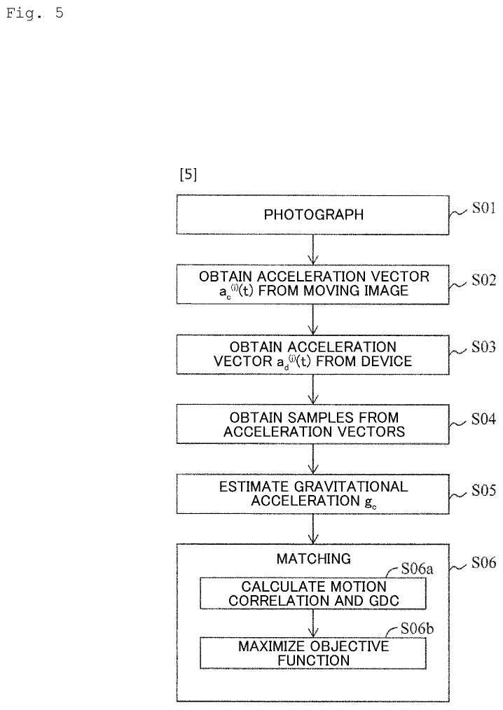

FIG. 5 illustrates a photographed target matching method using the photographed target matching device 301. The photographed target matching method includes photographing a moving image including a plurality of targets to be photographed by the fixed camera 11 (step S01), obtaining, by the input unit 21, the acceleration vectors a_{c}^{(j)}(t) of the photographed targets from the moving image through the converting unit 15 (step S02), obtaining, by the input unit 21, acceleration vectors a_{d}⁽ⁱ⁾(t) from respective wearable devices 12 carried by the photographed targets (step S03), extracting, by the extracting unit 22, M samples from each of the acceleration vectors a_{c}^{(j)}(t) and the acceleration vectors a_{d}⁽ⁱ⁾(t) (step S04), estimating, by the estimating unit 23, a gravitational acceleration vector g_{c} or a gravitational acceleration vector g′_{c} in the coordinate system of the fixed camera by formulating simultaneous equations with Expression 5 or 6 from the samples (step S05), and adding, by the detecting unit 24, the gravitational acceleration vector g_{c}or the gravitational acceleration vector g′_{c} to the acceleration vector a_{c}^{(j)}(t) and comparing the result with the acceleration vector a_{d}⁽ⁱ⁾(t) to match the photographed target included in the moving image and data in the terminal (step S06).

Instep S06, step S06a and step S06b are performed. When performing steps S06a and S06b, the gravitational acceleration vector g_{c} and the gravitational acceleration vector g′_{c} are estimated for each combination of i, j, and τ from both Expressions 5 and 6 in step S05.

Then, the detecting unit 24 calculates motion similarity in Expression 7 and gravitational acceleration similarity in Expression 8 (step S06a). Then, the detecting unit 24 adds the motion similarity and the gravitational acceleration similarity as in Expression 9 and detects the combination of i, j, and τ which maximizes the result (step S06b).

### Other Embodiments

The photographed target matching device 301 can also be implemented by a computer and a program, and the program can be recorded in a recording medium or provided over a network.

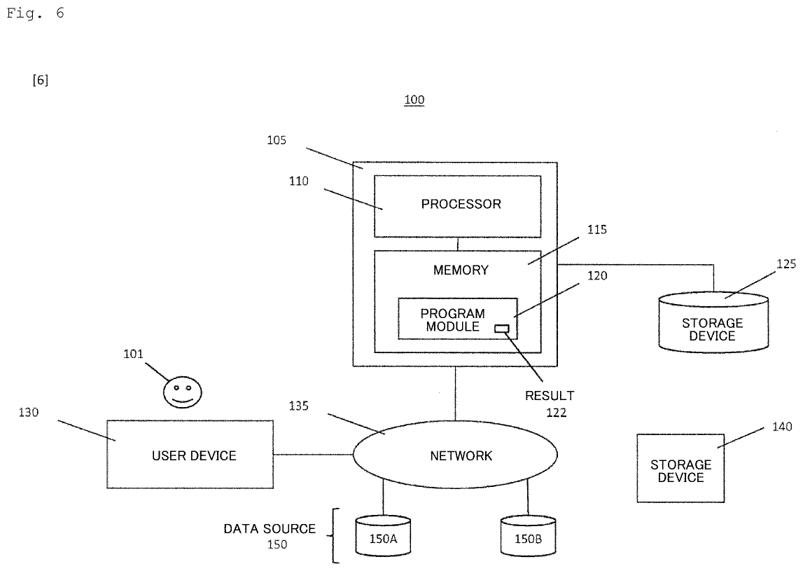

FIG. 6 is a block diagram of a system 100 corresponding to the photographed target matching device 301. The system 100 includes a computer 105 connected to a network 135.

The network 135 is a data communication network. The network 135 may be a private or public network and may include some or all of (a) a personal area network covering, for example, a room, (b) a local area network covering, for example, a building, (c) a campus area network covering, for example, a campus, (d) a metropolitan area network covering, for example, a city, (e) a wide area network covering, for example, an area connected across city, regional or national boundaries, and (f) the Internet. The communication is carried out by electronic and optical signals over the network 135.

The computer 105 includes a processor 110 and a memory 115 connected to the processor 110. Although the computer 105 is described herein as a standalone device, the computer arrangement is not limited in this manner, and the computer may be connected to any other device (which is not shown) in the distributed processing system.

The processor 110 is an electronic device including a logic circuit which responds to and executes instructions.

The memory 115 is a tangible computer-readable storage medium on which a computer program is encoded. In this regard, the memory 115 stores data and instructions, or program codes which can be read and executed by the processor 110 to control the operation of the processor 110. The memory 115 can be realized by a random access memory (RAM), a hard drive, or a read-only memory (ROM), or a combination thereof. One of the elements of the memory 115 is a program module 120.

The program module 120 includes an instruction for controlling the processor 110 to perform the process described herein. Herein, the kinds of operation are described as being executed by the computer 105 or a method or process or sub-processes thereof, but these kinds of operation are actually executed by the processor 110.

The term “module” is used herein to refer to functional operation which may be embodied either as a stand-alone component or an integrated configuration including a plurality of subordinate components. Therefore, the program module 120 can be realized as a single module or as a plurality of modules which operate in cooperation with one another. Although the program module 120 is described herein as being installed in the memory 115 and thus realized as software, the module can be realized as hardware (for example as electronic circuitry), firmware, software, or any combination thereof.

The program module 120 is illustrated as already being loaded in the memory 115 but may be configured to be located on the storage device 140 for later loading into the memory 115. The storage device 140 is a tangible, computer-readable storage medium which stores the program module 120. Examples of the storage device 140 include a compact disk, a magnetic tape, a read-only memory, an optical storage media, a memory unit including a hard drive or multiple parallel hard drives, and a Universal Serial Bus (USB) flash drive. Alternatively, the storage device 140 maybe a random access memory or any other kind of electronic storage device located in a remote storage system (which is not shown) and connected to the computer 105 over the network 135.

The system 100 further includes a data source 150A and a data source 150B collectively referred to herein as data sources 150 and communicatively connected to the network 135. In practice, the data source 150 may include any number of data sources, i.e., one or more data sources. The data source 150 can include non-systemized data and can include social media.

The system 100 further includes a user device 130 which is operated by the user 101 and connected to the computer 105 over the network 135. The user device 130 can be an input device such as a keyboard or a voice recognition subsystem for allowing the user 101 to communicate information and command selection to the processor 110. The user device 130 further includes an output device such as a display device or printer or a speech synthesizer. A cursor control unit such as a mouse device, a trackball, and a touch-sensitive screen allows the user 101 to manipulate the cursor on the display device to communicate further information and command selection to the processor 110.

The processor 110 outputs the results 122 of the execution of the program module 120 to the user device 130. Alternatively, the processor 110 can bring the output to a storage device 125 such as a database and a memory or to a remote device (which is not shown) over the network 135.

For example, the program which performs the flowchart in FIG. 5 can be the program module 120. The system 100 can be operated as the photographed target matching device 301.

It should be construed that the terms “comprises,” “comprising,” “includes,” or “including” specify the presence of stated features, integers, steps, or elements, but do not preclude the presence of one or more other features, integers, steps, or elements or groups thereof. The indefinite articles “a” and “an” do not preclude the presence of an embodiment including a plurality of the referenced items.

Note that the present invention is not limited by the above described embodiments but can be carried out in various forms without departing from the gist and scope of the invention. In short, the present invention is not limited by the above described embodiments as it is and can be embodied by the modification of components without departing from the gist and scope of the invention in the application.

Also, various inventions can be formed by appropriate combinations of the plurality of components disclosed in the above embodiments. For example, some components may be deleted from all components shown in the embodiments. Components across different embodiments may be combined as appropriate.

### INDUSTRIAL APPLICABILITY

The photographed target matching method, the photographed target matching device, and the program according to the present invention may be applied, for example, to integrating (person matching and time synchronization) video image data and sensor data with wearable terminals to produce a data set for analysis, or estimating and analyzing states such as actions and emotions of a person in a video image to create a multimodal data set.

### REFERENCE SIGNS LIST

11 Fixed camera
12 Wearable device carried by photographed target (person)
15 Converting unit
21 Input unit
22 Extracting unit
23 Estimating unit
24 Detecting unit
100 System
101 User
105 Computer
110 Processor
115 Memory
120 Program Module
122 Result
125 Storage Device
130 User Device
135 Network
140 Storage Device
150 Data Source

1. A photographed target matching method, comprising:
photographing a moving image including a plurality of targets to be photographed j by a fixed camera;
obtaining acceleration vectors a_{c}^{(j)}(t) of the photographed targets j from the moving image;
obtaining acceleration vectors a_{d}⁽ⁱ⁾(t) of terminals i carried by the photographed targets j;
estimating a gravitational acceleration vector g_{c} in a camera coordinate system for an arbitrary combination of the photographed target j and the terminal i from the acceleration vectors a_{c}^{(j)}(t) and the acceleration vectors a_{d}⁽ⁱ⁾(t); and
adding the gravitational acceleration vector g_{c} to the acceleration vector a_{c}^{(j)}(t) and comparing the result with the acceleration vector a_{d}⁽ⁱ⁾(t) to match the photographed target j included in the moving image and data in the terminal i.

2. The photographed target matching method according to claim 1, further comprising:
calculating motion similarity between the acceleration vector a_{d}⁽ⁱ⁾(t) and an acceleration obtained by adding the gravitational acceleration vector g_{c} to the acceleration vector a_{c}^{(j)}(t) in matching the photographed target j included in the moving image and the data in the terminal i;
calculating gravitational acceleration similarity between the gravitational acceleration vector g_{c} and the gravitational acceleration vector g′_{c} estimated assuming that the terminals i are synchronized in time; and
detecting a combination of the terminal i and the photographed target j which maximizes an objective function obtained as a weighted sum of the motion similarity and the gravitational acceleration similarity.

3. A photographed target matching device, comprising:
an input unit to which acceleration vectors a_{c}^{(j)}(t) of photographed targets j included in a moving image photographed by a fixed camera and acceleration vectors a_{d}⁽ⁱ⁾(t) measured by terminals i carried by the photographed targets j are input;
an estimating unit which estimates a gravitational acceleration vector g_{c} in a camera coordination system for an arbitrarily combination of the photographed target j and the terminal i from the acceleration vectors a_{c}^{(j)}(t) and the acceleration vectors a_{d}⁽ⁱ⁾(t); and
a detecting unit which adds the gravitational acceleration vector g_{c} to the acceleration vector a_{c}^{(j)}(t) and compares the result with the acceleration vector a_{d}⁽ⁱ⁾(t) to match the photographed target j included in the moving image and data in the terminal i.

4. The photographed target matching device according to claim 3, wherein
the estimating unit estimates the gravitational acceleration vector g′_{c} when it is assumed that the terminals i are synchronised in time, and
when the photographed target j included in the moving image and data in the terminal i are matched, the detecting unit calculates motion similarity between the acceleration vector a_{d}⁽ⁱ⁾(t) and acceleration obtained by adding the gravitational acceleration vector g_{c} to the acceleration vector a_{c}^{(j)}(t),
calculates gravitational acceleration similarity between the gravitational acceleration vector g_{c} and the gravitational acceleration vector g′_{c}, and
detects a combination of the terminal i and the photographed target j which maximises an objective function obtained as a weighted sum of the motion similarity and the gravitational acceleration similarity.

5. A program for causing a computer to execute a photographed target matching method, the photographed target matching method comprising:
photographing a moving image including a plurality of targets to be photographed j with a fixed camera;
obtaining acceleration vectors a_{c}^{(j)}(t) of the photographed targets j from the moving image;
obtaining acceleration vectors a_{d}⁽ⁱ⁾(t) from terminals i carried by the photographed targets j;
estimating a gravitational g_{c} in a camera coordinate system for an arbitrary combination of the photographed target j and the terminal i from the acceleration vectors a_{c}^{(j)}(t) and the acceleration vectors a_{d}⁽ⁱ⁾(t); and
adding the gravitational acceleration vector g_{c} to the acceleration vector a_{c}^{(j)}(t) and comparing the result with the acceleration vector a_{d}⁽ⁱ⁾(t) to match the photographed target j included in the moving image and data in the terminal i.

6. The program according to claim 5, wherein
when the photographed target j included in the moving image and the data in the terminal i are matched, the method further comprises:
calculating motion similarity between the acceleration vector a_{d}⁽ⁱ⁾(t) and an acceleration obtained by adding the gravitational acceleration vector g_{c} to the acceleration vector a_{c}^{(j)}(t);
calculating gravitational acceleration similarity between the gravitational acceleration vector g_{c} and the gravitational acceleration vector g′_{c} on the basis of the assumption that the terminals i are synchronised in time;
detecting a combination of the terminal i and the photographed target j which maximises an objective function obtained as a weighted sum of the motion similarity and the gravitational acceleration similarity.
